(19) United States
(12) Patent Application Publication
(10) Pub. No.: US 2021/0069842 A1
(43) Pub. Date: Mar. 11, 2021

(54) AIR TURBINE SPINDLE WITH TOOL HOLDER AND COOLANT THROUGH TO CUTTING BIT

(71) Applicant: First Eastern Equities Limited, Boca Raton, FL (US)

(72) Inventor: Kemma Samuel DODDS, North Lauderdale, FL (US)

(21) Appl. No.: 16/563,024

(22) Filed: Sep. 6, 2019

(51) Int. Cl. B23Q 3/157

(52) U.S. Cl. CPC B23Q 3/15706

(57) ABSTRACT

A pneumatic spindle with coolant through to the cutting bit is described. The pneumatic spindle includes a shank with a shank first end (USMA). A rotary union housing that is adapted to rotatably couple to the shank. A floating rotary union seal is rotatably coupled to an internal passage of rotary union housing. The rotary union housing includes a second end formed with a threaded circular opening and the pneumatic spindle first end is threaded to rotatably join with the threaded circular opening of the rotary union housing. The floating rotary union seal includes a first end, a floating rotary union seal second end and a floating rotary union seal internal passage. The floating rotary union seal second end formed as a circular bearing surface, and the floating rotary union seal internal passage directs the coolant fluid between the floating rotary union seal first end and the floating rotary union seal second end.

### CROSS-REFERENCE TO RELATED APPLICATIONS

This application is related to and claims priority to U.S. Provisional Patent Application No. 62/737,953, entitled “AIR TURBINE SPINDLE WITH TOOL HOLDER AND COOLANT THROUGH TO CUTTING BIT” filed on Sep. 9, 2018 with Attorney Docket Number 9093-V0009, which is assigned to the same assignee as this application and the teachings of which are herein incorporated by reference in its entirety.

### FIELD OF THE INVENTION

This disclosure relates generally to machining processes and more specifically to an apparatus and method for machining.

### BACKGROUND

Computer Numerical Control (CNC) machines are utilized in machining processes, and utilize a computer controller that typically reads G-code instructions for driving a powered mechanical device that is used to fabricate metal components by the selective removal of metal. CNC can do numerically directed interpolation of a cutting tool in the work envelope of a machine.

The powered mechanical device is often a pneumatic tool (e.g., a drill) that is fitted for coupling with the CNC machine, such as by insertion into and withdrawal from a CNC machine. The pneumatic tools or spindles can be manually coupled with the CNC machine or an automatic tool changer can be utilized.

Some tools are available from a CNC tool magazine, but require that the machine be stopped after change-over so that suitable power connections can be established with the tool. Other tools are pre-connected to the pneumatic source, but must be manually engaged with the CNC machine. Thus, CNC machines are typically programmed to stop prior to the normal machining cycle to permit manual tool installation or creation of a suitable power link with the tool after coupling with the machine.

### SUMMARY

An apparatus for machining is provided. The features of the examples described herein allows for machining while facilitating the tool exchanging process. These features can also provide flexibility to use various types of tools with the CNC system.

In one example described is an auto changer spindle mounting assembly for a spindle mounted pneumatic tool to a CNC system. The auto change spindle mounting assembly includes a shank with a shank first end, a shank second end and a shank internal passage. The shank first end is adapted to selectively couple with the CNC system. The shank internal passage directs a coolant fluid between the shank first end and the shank second end.

The auto change spindle mounting assembly further includes a rotary union housing with a rotary union housing first end, a rotary union housing second end, a rotary union housing internal passage and a compressed air gas inlet in fluid communications with a gas passage. The gas or air inlet is releasably coupled to a supply line. The rotary union housing first end is adapted to be rotatably coupled to the shank second end. The rotary union housing internal passage directs the coolant fluid between the rotary union housing first end and the rotary union housing second end. In one embodiment the rotary union housing includes a coolant drain passage with a first end at the gas seal formed between the floating rotary union seal and the rotary union first end and the coolant drain passage with a second end formed as an outlet on an external surface of the rotary union housing.

The auto change spindle mounting assembly further includes a floating rotary union seal with a floating rotary union seal first end, a floating rotary union seal second end and a floating rotary union seal internal passage the rotary union first end adapted to rotatably couple to an inside portion of the rotary union housing second end. The floating rotary union seal second end is formed as a circular bearing surface, and the floating rotary union seal internal passage directs the coolant fluid between the floating rotary union seal first end and the floating rotary union seal second end. In one embodiment the floating rotary union seal includes one or more gas seals disposed between the rotary union first end and the rotary union second end. In another embodiment the shank internal passage near the shank second end includes threads and the floating rotary union seal first end is threaded to rotatably join with the threads in the shank internal passage. The shank internal passage near the shank second end includes threads and the floating rotary union seal first end threaded to rotatably join with the threads in the shank internal passage. In another embodiment the rotary union second end includes threads and the shaft internal passage at the shaft first end is threaded to rotatably join with the threads of the rotary union. In still another embodiment rotary union housing second end forms a threaded circular opening and the pneumatic spindle first end is threaded to rotatably join with the threaded circular opening.

The auto change spindle mounting assembly further includes a rotary union with a rotary union first end, a rotary union second end and a rotary union internal passage, the rotary union first end adapted to rotate against the circular bearing surface of the floating rotary union seal thereby forming a gas seal there between. The rotary union internal passage directs the coolant fluid between the rotary union first end and the rotary union second end. In one embodiment the rotary union further includes one or more gas seals disposed between the rotary union first end and the rotary union second end. In another embodiment, a spring is disposed between the floating rotary union seal first end and the floating rotary union seal second end to urge the floating rotary union seal second end towards the rotary union first end.

The auto change spindle mounting assembly further includes a shaft with a shaft first end, a shaft second end and a shaft internal passage, the shaft first end adapted to rotatably coupled with the rotary union second end and the shaft internal passage for directing the coolant fluid between the shaft first end and the shaft send end. In one embodiment the shaft second end includes threads and the pneumatic spindle internal passage at the pneumatic spindle first end is threaded to rotatably join with the threads of the shaft.

The auto change spindle mounting assembly further includes a pneumatic spindle with a pneumatic spindle first end for rotatably coupling with the rotary union housing second end and in fluid communication with a gas inlet and a gas passage of the rotary union housing for directing gas to power the pneumatic spindle separate from the coolant fluid. A pneumatic spindle second end holds a cutting bit, and a pneumatic spindle internal passage, an air turbine motor disposed around the pneumatic spindle internal passage, the pneumatic spindle internal passage adapted to receive the shaft second end therein. The rotary union seat, the rotary union, and the shaft all fit within the rotary union housing internal passage and pneumatic spindle internal passage when assembled together thereby providing for a continuous coolant fluid passage from the shank first end to the pneumatic spindle second end.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is perspective view of an exemplary machining system according to an embodiment of the present invention;

FIG. 2 is a perspective view of another portion of the system of FIG. 1;

FIG. 3 is an exploded side view of a disassembled auto changer spindle mounting assembly of the system of FIG. 1;

FIG. 4 is an exploded side view showing further details of FIG. 3;

FIG. 5 is a side view of the assembled mounting assembly of FIG. 3;

FIG. 6 is a side view of a portion of the mounting assembly of FIG. 3;

FIG. 7 is a side view of the floating rotary union seal and rotary union of FIG. 3;

FIG. 8 is a side view of the shank, the rotary union seal, and the rotary union of FIG. 3; and

FIG. 9 is side view of an assembled rotary union and shaft of FIG. 3.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the disclosed subject matter in virtually any appropriately detailed structure and function. Further, the terms and phrases used herein are not intended to be limiting, but rather, to provide an understandable description.

The terms “a” or “an”, as used herein, are defined as one or more than one. The term plurality, as used herein, is defined as two or more than two. The term another, as used herein, is defined as at least a second or more. The terms “including” and “having” as used herein, are defined as comprising (i.e. open language). The term “coupled” as used herein, is defined as “connected” although not necessarily directly, and not necessarily mechanically.

The term “air” is intended to broadly cover many different types of fluids, including oil mixed with air. Various materials or combinations of materials can be used to construct the mounting collar assembly and its components. For example, materials such as metals, alloys, composites, plastics, ceramics, and other inorganic or organic materials or combinations thereof may be used.

The term “seal” is typically a ring of rubber, synthetic, plastic, metallic or combination used to prevent gas and liquids from passing around it.

The term “spring” is a resilient device, typically a helical coil fabricated from metal, plastic or composite, that can be pressed but returns to its former shape when released, used chiefly to exert constant tension. A spring constant is a characteristic of a spring which is defined as the ratio of the force affecting the spring to the displacement caused by it.

### Machining System

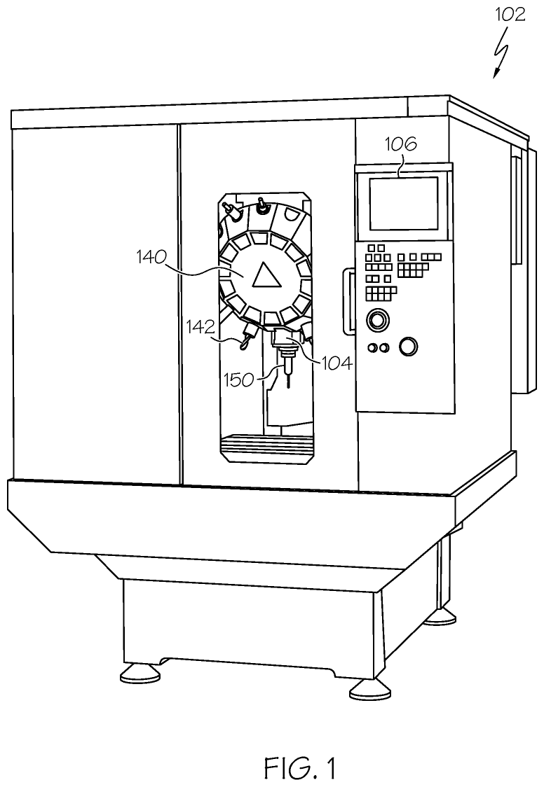

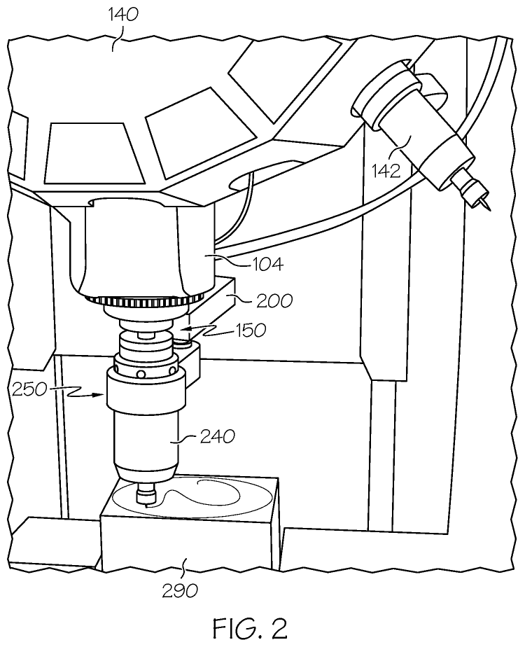

Referring to the drawings and in particular to FIGS. 1-2, a machining system is shown and generally represented by reference numeral 102. In this example, this is an auto changer spindle mounting assembly for a spindle mounted pneumatic tool that is powered by a compressed fluid, such as air. System 102 can include a control device 104, such as a CNC machine, a tool carousel 140, and one or more tools or spindles 142. The control device 104 can include a user input device 106 for inputting commands The control device 104 can utilize various computational hardware and software to implement a machining process on a work piece, and the present disclosure is not intended to be limited based upon the type of control utilized.

The system 102 can also have a universal spindle mounting assembly (USMA) 150 that cooperates with the spindles 142 to allow for automatic exchanging of the spindles with the CNC machine 104. In the exemplary embodiment of system 102, the spindles 142 are exchanged between the CNC machine 104 and the tool carousel 140 by way of an auto changer device, which will be explained later in greater detail. However, the present disclosure contemplates the use of other structures and techniques for connecting and disconnecting the spindles 142 with the CNC machine 104 through use of the USMA 150, such as a linear carousel.

Referring to FIG. 2, the USMA 150 can include a mounting collar assembly 250 and a mounting block or manifold body 200. The mounting collar assembly 250 can be operably coupled to a mounting collar assembly 240 which holds the spindle 240 parallel to the earth as shown, while the mounting block or manifold body 200 can be operably coupled to the CNC machine 104. A workpiece 290 is shown being machined with system 102.

### Coolant through Mounting Assembly

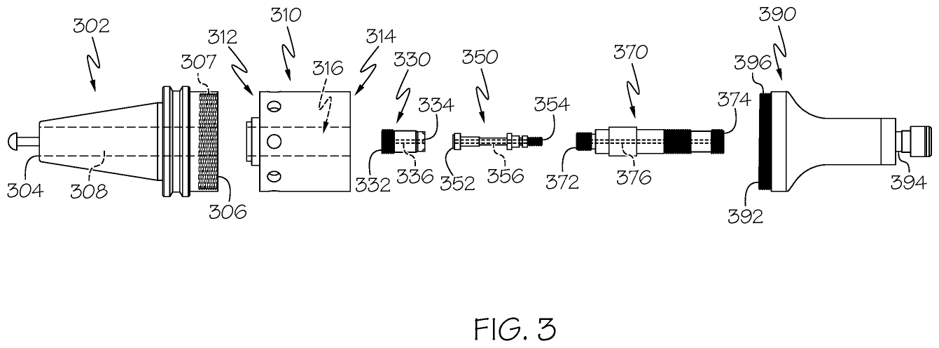

FIG. 3 is a side view of a spindle and mounting collar assembly of the system of FIG. 1. Beginning from the left side shown is a shank 302 with a shank first end (USMA) 150/304 to mechanically couple with CNC machine 104. Next is a rotary union housing 310 that is adapted to rotatably coupled or threaded to the shank 302. A floating rotary union seal 330 is rotatably coupled or threaded to an internal passage of rotary union housing 310 as further described below. The rotary union housing 310 includes a second end 314 formed with a threaded circular opening 307 and the pneumatic spindle first end 392 is threaded 396 to rotatably join with the threaded circular opening of the rotary union housing 310.

More specifically shown is the shank 302 with a shank first end 304, a shank second end 306 and a shank internal passage 308. The shank first end 302 adapted to selectively couple with the computer controlled machine 104, and the shank internal passage 308 for directing a coolant fluid between the shank first end 304 and the shank second end 306. Coolant under pressure is introduced through shank first end 304.

A rotary union 350 is threaded into shaft 370. The shaft has a first end 372, a second end 374 and an internal passage 376. The shaft second end 376 includes threads 478 and the pneumatic spindle internal passage 396 at the pneumatic spindle first end 392 is threaded 458 to rotatably join with the internal threads 472 of the shaft 470.

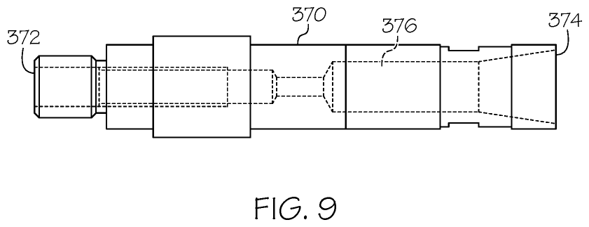

Both the rotary union shaft 370 and rotary union 350 are threaded into a first end 392 of a spindle 390. The second end 394 of the spindle includes a cutting bit. Further details of the shaft 370 including internal passage 376 from FIG. 3 is shown in FIG. 9.

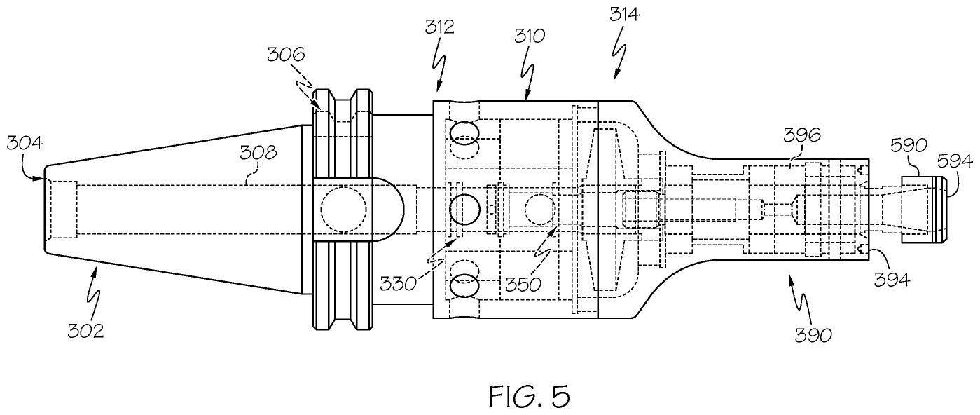

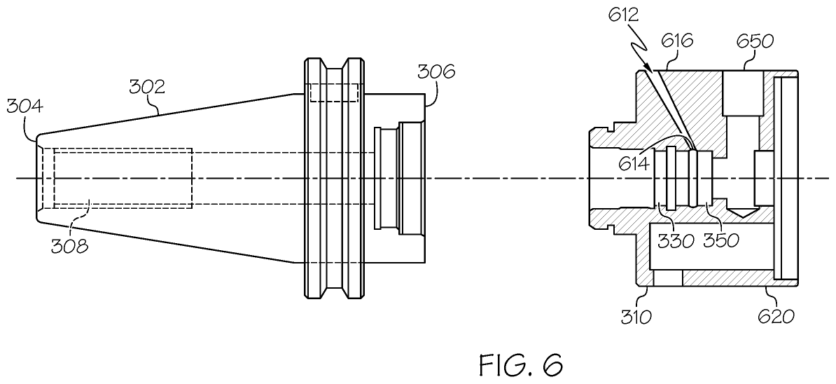

A rotary union housing 310 is shown with a rotary union housing first end 312, a rotary union housing second end 314, a rotary union housing internal passage 316 and a compressed air gas inlet (650 of FIG. 6) in fluid communications with a gas passage (396 of FIG. 5). The gas passage (396 of FIG. 5) drives uses compress fluid, such as air, to drive the air spindle separate from the coolant. The rotary union housing internal passage 316 for directing the coolant fluid between the rotary union housing first end 312 and the rotary union housing second end 314. The rotary union housing first end 312 adapted to be rotatably coupled to the shank second end 316.

A rotary union 350 is shown with a rotary union first end 352, a rotary union second end 354 and a rotary union internal passage 356. The rotary union first end 352 adapted to rotate against the circular bearing surface, i.e. the second end 334 of the floating rotary union seal 330, thereby forming a gas seal there between. The floating rotary union seal 330 has a first end 332 that rotatably couples, typically with threads to engage corresponding threads (not shown) of the rotary union housing 310. The rotary union internal passage 356 directs the coolant fluid between the rotary union first end 352 and the rotary union second end 354.

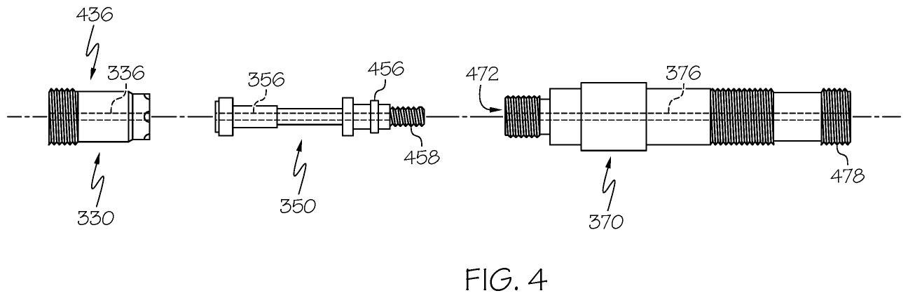

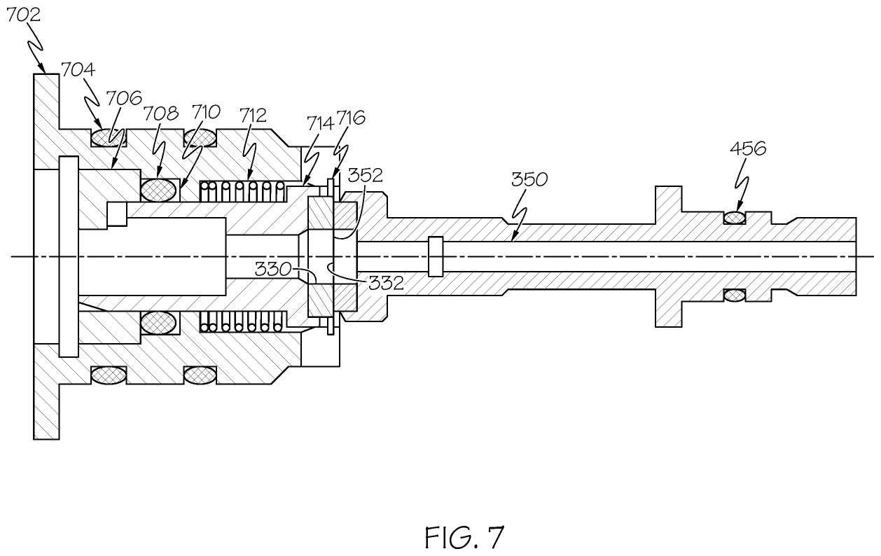

FIG. 4 is an exploded side view showing further details of FIG. 3. The floating rotary union seal 330 includes an internal seal (704 as shown in FIG. 7). The rotary union 350 has a seal 456 disposed between the rotary union first end 352 and the rotary union second end 354.

FIG. 5 is a side view of the assembled mounting assembly of FIG. 3. Shown are the internal passages 308, 336, 356, 376, 396 for each of the shank 302, the rotary union housing 310, the floating rotary union seal 330, the rotary union 350, the shaft 370 and the spindle 390 respectively. When the floating rotary union seal 330, the rotary union 350, and the shaft all 370 fit within an internal passage of the rotary union housing 310 and an internal passage of the pneumatic spindle 390 when assembled together thereby providing for a continuous coolant fluid passage from the shank first end 304 to the pneumatic spindle second end 394 through a collet 590 out the collet end 594 which would hold the cutting bit (not shown).

FIG. 6 is a side view of a portion of the mounting assembly of FIG. 3 illustrating further details of the shank 302 and the rotary union 350. In one example, rotary union housing 310 further includes a coolant drain passage 612 with a first end 614 at the gas seal formed between the floating rotary union seal 330 and the rotary union first end 352. The coolant drain passage 612 with a second end 616 formed as an outlet on an external surface 620 of the rotary union housing 310.

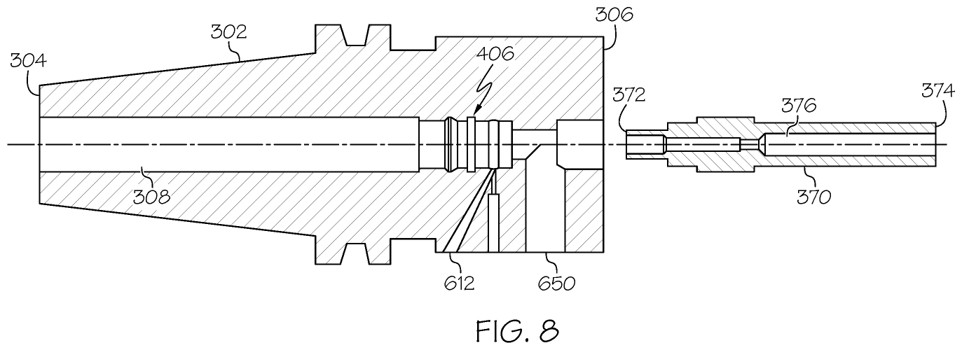

FIG. 8 is a side view illustrating further details of the shank 302 shank, the rotary union seal 406, and the shaft 370 of FIG. 3.

FIG. 7 is a side view of the floating rotary union seal 330 and rotary union 350 of FIG. 3 illustrating further details in another embodiment. Starting from the left shown is a flange 702 with two periphery seals 704 and 710. An internal stop 706 with a seal 708 is shown. A spring 712 is used to urge the second end 334 of the floating rotary union seal 330 against the rotary union first end 352 of the rotary union thereby creating the seal. The spring 712 strength or spring constant is selected to keep the seal formed for operating pressures of the coolant being passed there through. Stop 714 is a stop for floating rotary union seal 330. 716 matting seat for floating rotary union seal 330.

### NON-LIMITING EXAMPLES

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed as the best mode contemplated for carrying out this invention, but that the invention will include all embodiments falling within the scope of the appended claims.

What is claimed is:

1. An auto changer spindle mounting assembly for a spindle mounted pneumatic tool to a computer controlled machining system, the auto change spindle mounting assembly comprising:
a shank with a shank first end, a shank second end and a shank internal passage, the shank first end adapted to selectively couple with the computer controlled tool, and the shank internal passage for directing a coolant fluid between the shank first end and the shank second end;
a rotary union housing with a rotary union housing first end, a rotary union housing second end, a rotary union housing internal passage and a compressed air gas inlet in fluid communications with a gas passage, the rotary union housing first end adapted to be rotatably coupled to the shank second end, the rotary union housing internal passage for directing the coolant fluid between the rotary union housing first end and the rotary union housing second end;
a floating rotary union seal with a floating rotary union seal first end, a floating rotary union seal second end and a floating rotary union seal internal passage the rotary union first end adapted to rotatably couple to an inside portion of the rotary union housing second end, the floating rotary union seal second end formed as a circular bearing surface, and the floating rotary union seal internal passage for directing the coolant fluid between the floating rotary union seal first end and the floating rotary union seal second end;
a rotary union with a rotary union first end, a rotary union second end and a rotary union internal passage, the rotary union first end adapted to rotate against the circular bearing surface of the floating rotary union seal thereby forming a gas seal there between, the rotary union internal passage for directing the coolant fluid between the rotary union first end and the rotary union second end;
a shaft with a shaft first end, a shaft second end and a shaft internal passage, the shaft first end adapted to rotatably coupled with the rotary union second end and the shaft internal passage for directing the coolant fluid between the shaft first end and the shaft send end; and
a pneumatic spindle with a pneumatic spindle first end for rotatably coupling with the rotary union housing second end and in fluid communication with a gas inlet and a gas passage of the rotary union housing for directing gas to power the pneumatic spindle separate from the coolant fluid, a pneumatic spindle second end for holding a cutting bit, and a pneumatic spindle internal passage, an air turbine motor disposed around the pneumatic spindle internal passage, the pneumatic spindle internal passage adapted to receive the shaft second end therein, whereby the rotary union seat, the rotary union, and the shaft all fit within the rotary union housing internal passage and pneumatic spindle internal passage when assembled together thereby providing for a continuous coolant fluid passage from the shank first end to the pneumatic spindle second end.

2. The auto changer spindle mounting assembly of claim 1, wherein the rotary union further includes at least one gas seal disposed between the rotary union first end and the rotary union second end.

3. The auto changer spindle mounting assembly of claim 1, wherein the floating rotary union seal further includes at least one gas seal disposed between the rotary union first end and the rotary union second end.

4. The auto changer spindle mounting assembly of claim 1, wherein the rotary union housing further includes a coolant drain passage with a first end at the gas seal formed between the floating rotary union seal and the rotary union first end and the coolant drain passage with a second end formed as an outlet on an external surface of the rotary union housing.

5. The auto changer spindle mounting assembly of claim 1, wherein the shank internal passage near the shank second end includes threads and the floating rotary union seal first end is threaded to rotatably join with the threads in the shank internal passage.

6. The auto changer spindle mounting assembly of claim 1, wherein the shank internal passage near the shank second end includes threads and the floating rotary union seal first end is threaded to rotatably join with the threads in the shank internal passage.

7. The auto changer spindle mounting assembly of claim 1, wherein the rotary union second end includes threads and the shaft internal passage at the shaft first end is threaded to rotatably join with the threads of the rotary union.

8. The auto changer spindle mounting assembly of claim 1, wherein the shaft second end includes threads and the pneumatic spindle internal passage at the pneumatic spindle first end is threaded to rotatably join with the threads of the shaft.

9. The auto changer spindle mounting assembly of claim 1, wherein the rotary union housing second end forms a threaded circular opening and the pneumatic spindle first end is threaded to rotatably join with the threaded circular opening.

10. The auto changer spindle mounting assembly of claim 1, further comprising:
an air supply line releasably attached to the gas inlet.

11. The auto changer spindle mounting assembly of claim 1, further comprising:
a spring disposed between the floating rotary union seal first end and the floating rotary union seal second end to urge the floating rotary union seal second end towards the rotary union first end.

12. A machining system comprising:
a spindle;
a computer numerical control (CNC) machine;
an auto changer device;
a gas supply line; and
a mounting assembly including
a shank with a shank first end, a shank second end and a shank internal passage, the shank first end adapted to selectively couple with the CNC machine, and the shank internal passage for directing a coolant fluid between the shank first end and the shank second end;
a rotary union housing with a rotary union housing first end, a rotary union housing second end, a rotary union housing internal passage and a compressed air gas inlet in fluid communications with a gas passage, the rotary union housing first end adapted to be rotatably coupled to the shank second end, the rotary union housing internal passage for directing the coolant fluid between the rotary union housing first end and the rotary union housing second end;
a floating rotary union seal with a floating rotary union seal first end, a floating rotary union seal second end and a floating rotary union seal internal passage the rotary union first end adapted to rotatably couple to an inside portion of the rotary union housing second end, the floating rotary union seal second end formed as a circular bearing surface, and the floating rotary union seal internal passage for directing the coolant fluid between the floating rotary union seal first end and the floating rotary union seal second end;
a rotary union with a rotary union first end, a rotary union second end and a rotary union internal passage, the rotary union first end adapted to rotate against the circular bearing surface of the floating rotary union seal thereby forming a gas seal there between, the rotary union internal passage for directing the coolant fluid between the rotary union first end and the rotary union second end;
a shaft with a shaft first end, a shaft second end and a shaft internal passage, the shaft first end adapted to rotatably coupled with the rotary union second end and the shaft internal passage for directing the coolant fluid between the shaft first end and the shaft send end; and
a pneumatic spindle with a pneumatic spindle first end for rotatably coupling with the rotary union housing second end and in fluid communication with the gas passage of the rotary union housing for directing gas to power the pneumatic spindle separate from the coolant fluid, a pneumatic spindle second end for holding a cutting bit, and a pneumatic spindle internal passage, an air turbine motor disposed around the pneumatic spindle internal passage, the pneumatic spindle internal passage adapted to receive the shaft second end therein, whereby the rotary union seat, the rotary union, and the shaft all fit within the rotary union housing internal passage and pneumatic spindle internal passage when assembled together thereby providing for a continuous coolant fluid passage from the shank first end to the pneumatic spindle second end.

13. The machining system of claim 12, wherein the rotary union further includes at least one gas seal disposed between the rotary union first end and the rotary union second end.

14. The machining system of claim 12, wherein the floating rotary union seal further includes at least one gas seal disposed between the rotary union first end and the rotary union second end.

15. The machining system of claim 12, wherein the rotary union housing further includes a coolant drain passage with a first end at the gas seal formed between the floating rotary union seal and the rotary union first end and the coolant drain passage with a second end formed as an outlet on an external surface of the rotary union housing.

16. The machining system of claim 12, wherein the shank internal passage near the shank second end includes threads and the floating rotary union seal first end is threaded to rotatably join with the threads in the shank internal passage.

17. The machining system of claim 12, wherein the shank internal passage near the shank second end includes threads and the floating rotary union seal first end is threaded to rotatably join with the threads in the shank internal passage.

18. The machining system of claim 12, wherein the rotary union second end includes threads and the shaft internal passage at the shaft first end is threaded to rotatably join with the threads of the rotary union.

19. The machining system of claim 12, wherein the shaft second end includes threads and the pneumatic spindle internal passage at the pneumatic spindle first end is threaded to rotatably join with the threads of the shaft.

20. The machining system of claim 12, further comprising:
a spring disposed between the floating rotary union seal first end and the floating rotary union seal second end to urge the floating rotary union seal second end towards the rotary union first end.
